(19) United States
(12) Patent Application Publication
(10) Pub. No.: US 2002/0138500 A1
(43) Pub. Date: Sep. 26, 2002

(54) Virtual streaming in a carousel file system

(75) Inventors: Gordon Bechtel, Newburyport, MA (US); Terence Brogan, Norton, MA (US); John Marcolini, Manchester, MA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument Corporation

(21) Appl. No.: 10/043,643

(22) Filed: Jan. 11, 2002

Related U.S. Application Data
(60) Provisional application No. 60/261,693, filed on Jan. 12, 2001.

(51) Int. Cl. G06F 7/00; G06F 17/00; H04N 7/173; G06F 9/00; G06F 9/46

(52) U.S. Cl. 707/104.1; 709/328; 725/114; 725/131

(57) ABSTRACT

A carousel file server at a headend of a broadband network periodically and repeatedly streams application data files over in-band or out-of-band delivery paths (or a combination of both) to client applications running on a population of set-top terminals in a network. The carousel server streams multiple virtual streams carrying multicast addresses into a single downstream service (i.e., a PID stream) within a stream set using standard MPEG-2 transport protocols. The virtual streaming implemented by the multicast addressing provides another level of filtering so that set-top terminals in the network may access application data files beyond that enabled by PID filtering. The application data files in the virtual file system are flexibly partitioned among the virtual streams (or across the stream set) to thereby create a virtual file system.

### BACKGROUND OF THE INVENTION

The present invention relates generally to a system and method for providing a virtual file system to client applications running on digital cable consumer terminals such as set-top terminals employed in digital cable television systems.

Cable television network operators (commonly referred to as multiple system operators or “MSOs”) increasingly provide interactive entertainment services to consumers in digital form. Such services include television programming, electronic program guides (“EPG”), video-on-demand (“VOD”), web-browsing, email, shop-at-home services, games and others. The Moving Pictures Expert Group standard two (“MPEG-2 ”) is currently used for digital television and is expected to be the basis for the nextgeneration high-definition television as well. With digital services, one or more MPEG-2 compliant data streams may be modulated onto a common transport medium such as a hybrid fiber co-axial (“HFC”) network between a controller (at the headend of network) and client applications (running on a set-top terminal in the consumer's location).

At the set-top terminal, the data streams are received from the upstream headend. A packet, or program identifier filter (“PID” filter), that is typically implemented in hardware or firmware in the set-top terminal, filters the MPEG-2 data streams (called a “PID stream”) to identify packets within the MPEG-2 data streams as belonging to a particular provisioned service (i.e., a “PID service”) such as a specific television program, movie, or station. The PID filter is located upstream from the MPEG-2 decoder within the set-top terminal and allows the set-top terminal to access the desired interactive service from the headend while eliminating the burden of decoding inappropriate services.

In addition to program data, client applications on the set-top terminal generally require access to files stored at the headend to implement the interactive services at the set-top terminal. For example, an electronic program guide application requires receipt of data files pertaining to location-specific television programming schedule that it formats to populate the guide which is displayed to the consumer. Hypertext Mark Up Language (“HTML”) data required by a web-browsing application running on the set-top terminal is another example of a data file that may be stored at the headend and used to implement an interactive feature. Typically, such data files are sent in an out-of-band data path between the headend and the set-top terminal.

While current digital delivery systems are entirely satisfactory in many applications, network configuration is made more complex and overhead requirements are increased as more PID services are accommodated. For example, MSOs must often recode incoming services to create new downstream services (due to the limitations on out-of-band service bandwidth) which requires re-mapping PIDs and re-multiplexing the MPEG-2 data streams. In addition, the number of PID filters available in the set-top terminals is limited.

### SUMMARY OF THE INVENTION

A carousel file server at a headend of a broadband network periodically and repeatedly streams application data files over in-band or out-of-band delivery paths (or a combination of both) to client applications running on a population of set-top terminals in a network. The carousel server streams multiple virtual streams carrying multicast addresses into a single downstream service (i.e., a PID stream) within a stream set using standard MPEG-2 transport protocols. The virtual streaming implemented by the multicast addressing provides another level of filtering so that set-top terminals in the network may access application data files beyond that enabled by PID filtering. The application data files in the virtual file system are flexibly partitioned among the virtual streams (or across the stream set) to thereby create a virtual file system. The carousel server may support multiple carousels and virtual file systems simultaneously and may adjust the partitioning or data delivery rate for each virtual stream or stream set according to data type or priority, network status or bandwidth availability, user requirements, or file information including metadata.

A client application residing on the set-top terminal accesses files stored on the headend via an application program interface (“API”) that locates and reassembles files from the carousel. The API requires no more than one PID filter in the set-top terminal per carousel. The API includes wrapper functions that advantageously hides the complexity in requesting and receiving API messages from the client application when accessing and assembling the virtual files from the multiple virtual streams or stream set. The client application may thus receive virtual directory information and mount files from the carousel as needed to support the specific needs of the client application. Virtual streams and stream sets may be configured by the API to contain data files within all or only specific virtual directories. Time sensitive data (i.e., relevant to a particular time window, for example between 8:00 and 9:00 am today for an EPG application) may be handled by imposing a sliding window definition to limit the number of application data files eligible for streaming based on applicability to the time window. Additional efficiency in bandwidth and processing utilization is realized through caching optimization at the set-top. The invention thus reduces demands on the set-top terminal by streamlining communications with the headend through simple file-oriented API calls.

The carousel file system employing virtual streams and files in accordance with the invention gives significant advantages to MSOs by reducing complexity in provisioning network services. For example, the use of multiple virtual streams in a single PID reduces channel map configuration requirements and lowers the hardware requirements and overhead associated with PID remapping and remultiplexing. In addition, the virtual streams allow MSOs to bypass out-of-band service limitations in the network as well as PID filter limitations in the set-top terminal.

### BRIEF DESCRIPTION OF THE DRAWING

FIG. 1 is a simplified functional block diagram of a headend including a carousel file server, transport medium, and set-top terminal, arranged in accordance with the invention;

FIG. 2 is a simplified diagram of the definable components of streams, stream sets and carousels in accordance with the invention;

FIG. 3 is a simplified diagram of networks objects defining an operations stream, in accordance with the invention;

FIG. 4 is a simplified diagram of a single downstream service including a plurality of virtual streams where each virtual stream has a multicast address, in accordance with the invention;

FIG. 5 is a simplified diagram of the MPEG-2 transport stream including a data stream and operations stream, in accordance with the invention;

FIG. 6 is a simplified functional block diagram of a API structure for the carousel file system, in accordance with the invention;

FIG. 7 is a simplified functional block diagram of a carousel server in accordance with the invention;

FIG. 8 is a simplified functional block diagram of a carousel manager, in accordance with the invention; and

FIG. 9 is a simplified functional block diagram of a carousel manager object hierarchy, in accordance with the invention.

### DETAILED DESCRIPTION

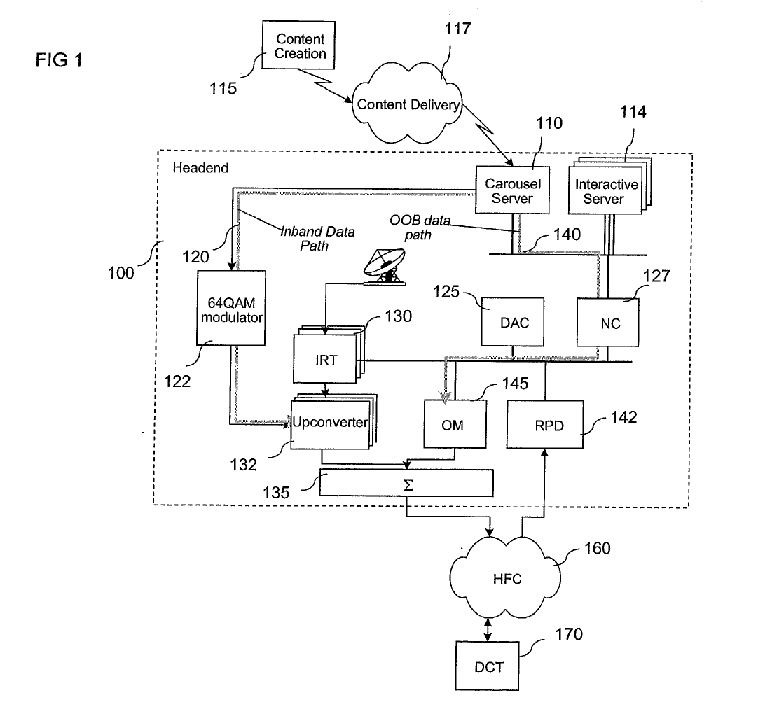

Referring to FIG. 1, there is shown a simplified functional block diagram of an illustrative embodiment that facilitates practice of the invention. A headend 100 is coupled via a cable network 160 to a set-top terminal 170. In this illustrative embodiment set-top terminal 170 is digital consumer terminal, referred to as a DCT. Cable network 160 is shown as an HFC network in FIG. 1. Content creation, that is the actual authoring of the application data files utilized in the invention, is shown as a process that is external to the headend 100, as indicated by reference numerals 115 and 117 in FIG. 1.

The carousel server 110 is realized in software code that typically runs on a hardware platform such as a rack mountable Sun Netra® server running a suitable operating system. In accordance with the invention, both in-band data path 120 and out-of-band data path 140 may be utilized, singularly or in combination, to provide data to the set-top terminal 170. Using the in-band path 120, data signals are processed by a QAM (Quadrature Amplitude Modulator) modulator 122 prior to being upconverted in upconverter 132. Examples of appropriate components include the Motorola IM-1000 modulators and Commander 6® C6U or Commander 8™ C8U upconverters, respectively. Using the out-of-band path 140, data signals are processed by out-of-band modulator 145, such as a Motorola OM-1000. The in-band and out-of-band data signal are multiplexed by multiplexer 135 prior to transport on cable network 160.

As shown in FIG. 1, data supporting other interactive applications may be provided by interactive server 114. In addition, headend 100 includes conventional elements such as digital addressable controller 125, network controller 127, integrated receiver transcoder 130, and return path demodulator 142 that are typically utilized by an MSO in provisioning interactive digital services to consumers on the cable network 160.

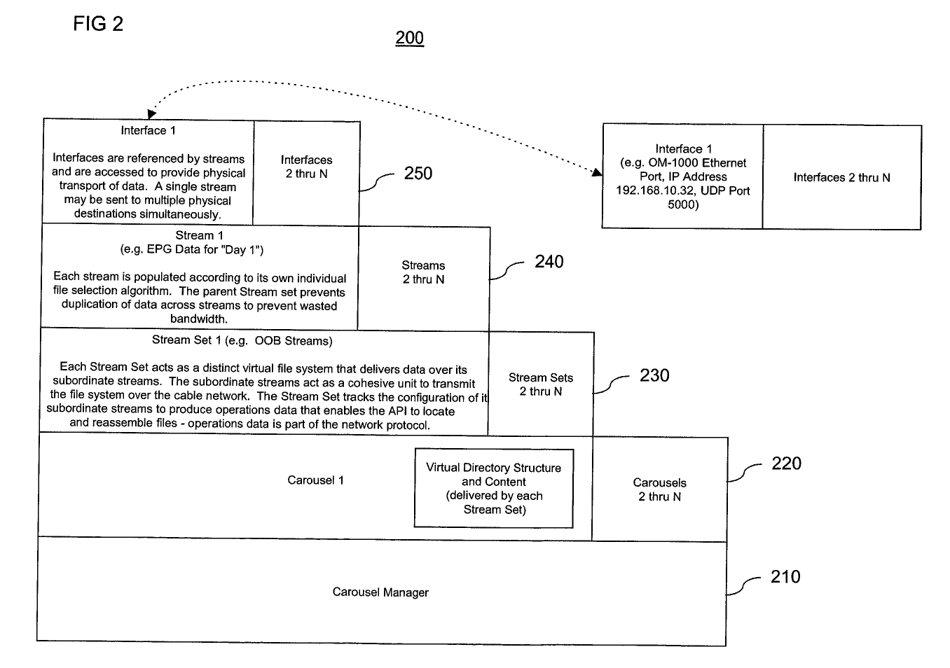

The carousel server 110 streams data to the set-top terminal 170 in accordance with the specific requirements of client applications running on the set-top. Accordingly, as shown in FIG. 2, multiple carousels, streams sets, streams may be defined within the carousel server structure and configured for specific applications of the invention. The relationship among these elements constitutes a hierarchical structure 200, and the adaptation of data into specific elements within the hierarchy (i.e., new stream configurations) may be automatically and transparently performed.

At the second tier of the hierarchy 220 in FIG. 2, a plurality of N carousels may be defined by the application or the interactive service provider (i.e., content provider). The carousels hold the virtual directory structure and the content delivered by each stream set. In accordance with the invention, the content maintained by the carousel is used by the subordinate stream sets in the hierarchical structure 200.

At the third tier of the hierarchy 230, each stream set may comprise a virtual file system. As indicated in FIG. 2, the actual data delivery occurs over the streams that are subordinate to the stream set in the hierarchy. As described in more detail below, an operations data stream is produced to track the subordinate streams to allow the client side API to locate and assemble the required application data files to support the client application on the set-top 170 (FIG. 1). In accordance with the invention, each stream set comprises one or more streams that may be used to deliver the application data files to the application on the set-top terminal 170. Application data files for a specific client application may be carried across more than one stream in the stream set to thus create a virtual file system that may be accessed by the client application via the API.

Moving to the fourth tier of the hierarchy 240, each stream is provided with a file selection algorithm to produce a “view” of the content contained within the parent carousel. Thus, application data files are populated onto the individual streams without duplication to avoid wasted bandwidth. In this illustrative example, as shown in the fourth tier 240, EPG data for “Day 1” is contained within Stream 1. Such data is time sensitive and thus Stream 1 may be provided, in accordance with the invention, with a defined sliding time window in which data files are eligible for population within the stream. Thus, data files which have no applicability to the defined time window are ineligible for output on Stream 1. Other streams 2, 3 . . . N in the stream set may contain time-sensitive or time-insensitive data files depending on the configuration of those streams set by the content provider or in accordance with the requirements of the client application.

In the fifth tier of the hierarchy 250, interfaces provide for the physical transport of the application data files across the cable network 160 (FIG. 1). As indicated in FIG. 2, a conventional physical communications interface that may carry MPEG-2 defined streams, is utilized in this illustrative embodiment.

Each stream in the fourth tier of the hierarchy shown in FIG. 2 includes two stream types: an operations stream and a data stream. The operations stream contains structured information describing the carousel and the virtual file system therein, and the data stream contains the actual application data files.

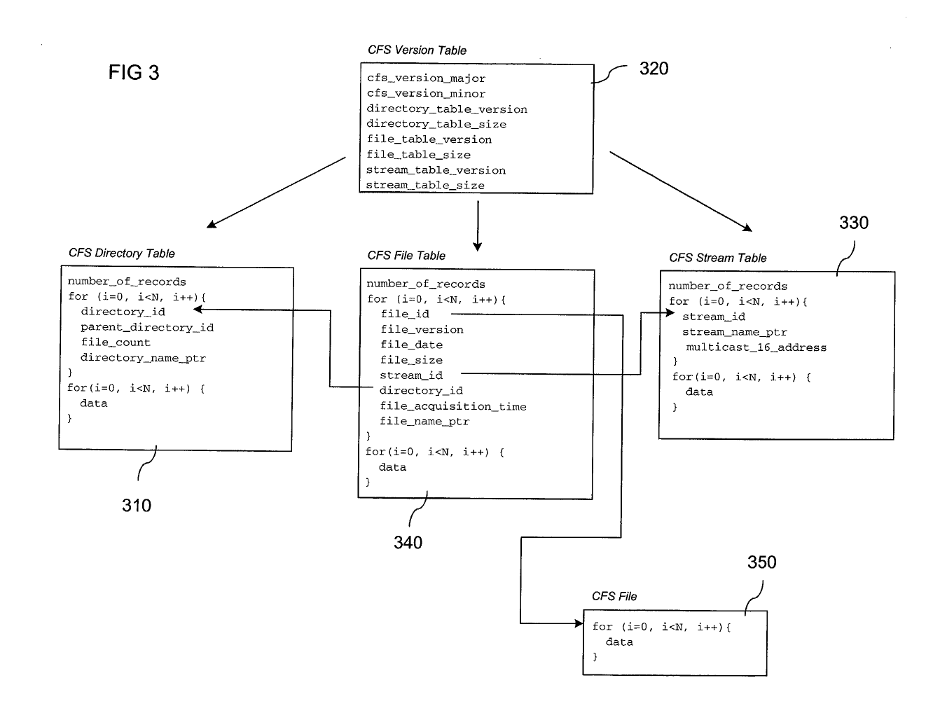

The operations stream is created when the content provider inserts content onto the carousel. As shown in FIG. 3, the operations stream is carried as a series of tables—a carousel file system directory table 310, version table 320, file table 340, and stream table 330. A message header starts each packet including those packets containing objects. That is, data files in the data stream and CFS tables forming the structured information are each objects in the MPEG-2 transport stream.

In accordance with the invention, the CFS stream table 330 contains a multicast address entry. By utilizing hardware filtering at the set-top terminal 170, a second level of filtering is advantageously enabled so that the set-top terminals in the network may access application data files beyond that enabled by PID filtering.

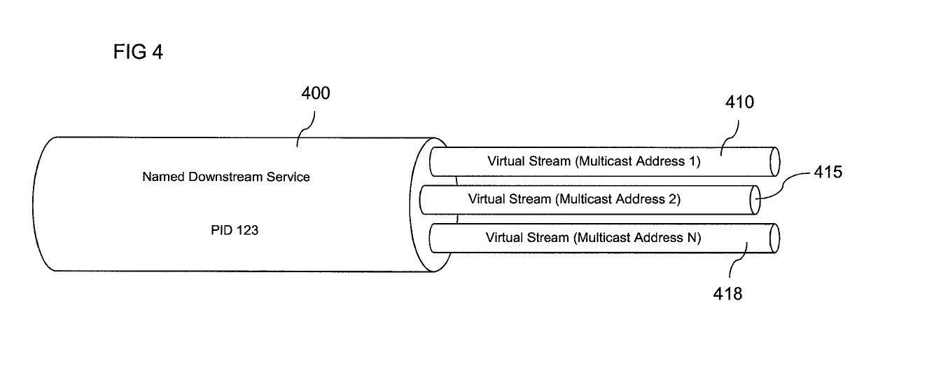

Referring now to FIG. 4, a simplified diagram of a single downstream service is depicted which includes a plurality of virtual streams where each virtual stream has a multicast address, in accordance with the invention. A stream 300 provisions a downstream service and carries the PID 123 in this illustrative example. By including a multicast address within the operations stream as described above, a plurality of virtual streams contained within the single downstream service (i.e., PID stream) is thereby created.

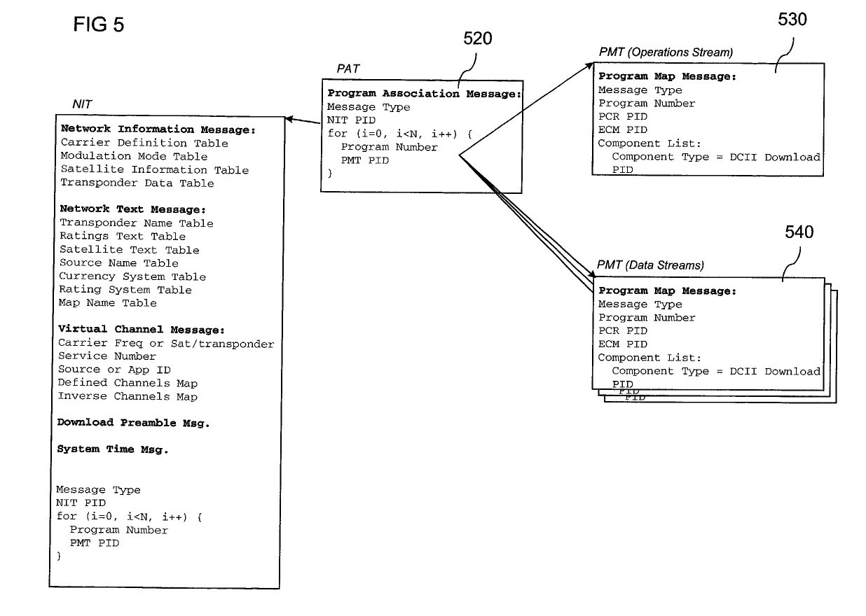

Referring now to FIG. 5, both the operations and data stream utilizes its own MPEG-2 program specific information (“PSI”) including transport stream PID and program name to provide basic tuning information. These are transmitted using standard MPEG-2 Program Association Tables (“PATs”) and Program Map Tables (“PMTs”). The PAT (indicated by reference numeral 520 in FIG. 4) lists all the programs (i.e., services) carried on the MPEG-2 transport stream, including the carousels. Each carousel stream is listed, as indicated, as a separate MPEG-2 program. The program (or service) names matches the stream names delivered in the operations stream to ensure proper tuning and stream access. The PMT (indicated by reference numerals 530 and 540, for the respective operations and data streams) simply carries the single PID corresponding to the desire data stream.

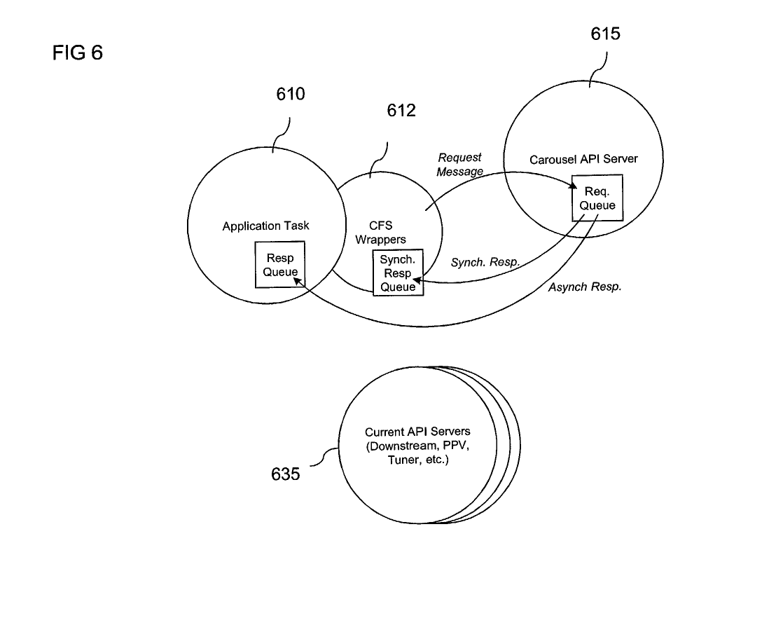

FIG. 6 is a simplified functional block diagram of a API structure for the carousel file system, in accordance with the invention. The API provides access to the virtual files. In the illustrative embodiment of the invention shown in FIG. 6, the API functions as another firmware API server 615. It may be accessed in a similar manner as other servers 635 including a downstream data, tuner, pay-per-view servers, etc. Wrappers 612 provide an interface to the application 610, as indicated in FIG. 6, to hide much of the server overhead used to access its functionality from the application. Wrappers 612 function as an interface between the caller and the wrapped code to transparently tune among various streams to obtain the desired data.

The client application resident on set-top terminal 170 (FIG. 1) accesses files stored at the headend 100 using a synchronous function-call/return approach. Accordingly, the client application may mount files, gather directory information and access the files. As shown in FIG. 6, an asynchronous response are utilized for those operations that may be particularly time consuming, such as file retrieval or directory listings, for example.

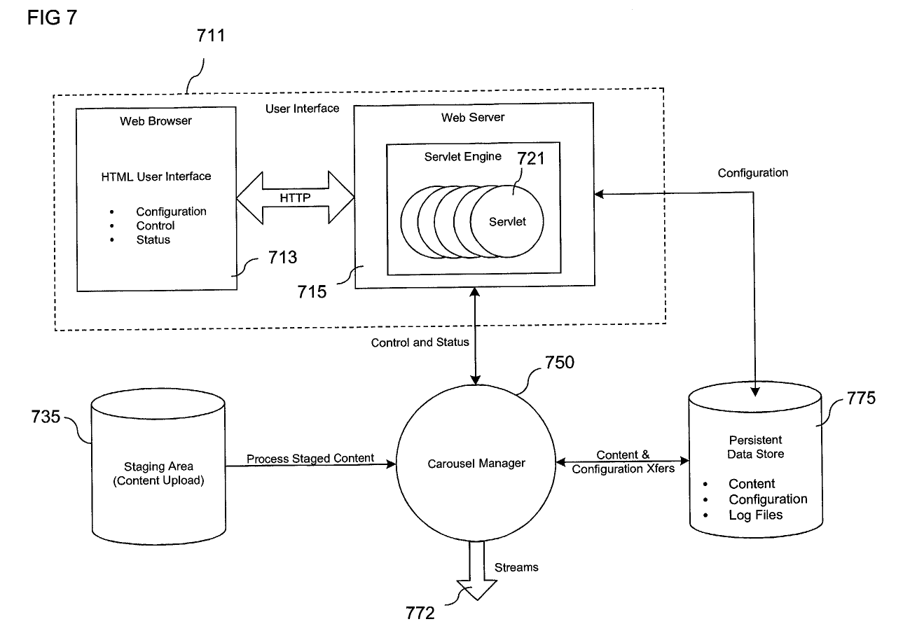

FIG. 7 is a simplified functional block diagram of a carousel server in accordance with the invention. A graphical user interface 711 allows a user such as a content provider to perform system management functions such as adding users, assigning user privileges, and password protected login verification. The user interface 711 further provides configuration capability for carousels, interfaces, streams, stream sets, and virtual streams. Status information pertaining to a carousel may be provided via the user interface and control functions, including those to start or stop individual carousels, may also be performed. The user interacts with the user interface to add, delete or modify data on the carousel. In addition, the user suppliers metadata to describe specific information associated with the data files such as the desired carousel to hold the data files, the desired data stream and bit rate, etc. In the illustrative example of the invention shown in FIG. 7, a conventional HTML based interface is utilized and is accessible via a standard web browser. HTML pages are dynamically generated by Java servlets 721 and served by web server 715.

The user interface 711 is coupled to a carousel manager 750 to exchange control commands and status signals bidirectionally. The carousel manager 750 creates and controls all configured carousels. It is further responsible for transmitting the application data files, streams 772, to the set-top terminals 170 (FIG. 1). A staging area 735 for content uploaded by a content creator is coupled to the carousel manager 750. The carousel manager 750 monitors the staging area 735 for new and/or modified content which it uploads to a persistent data store 775. Thus, as content changes, carousels may be kept up to date. The persistent data store may be implemented using a standard file and SQL (structured query language) database.

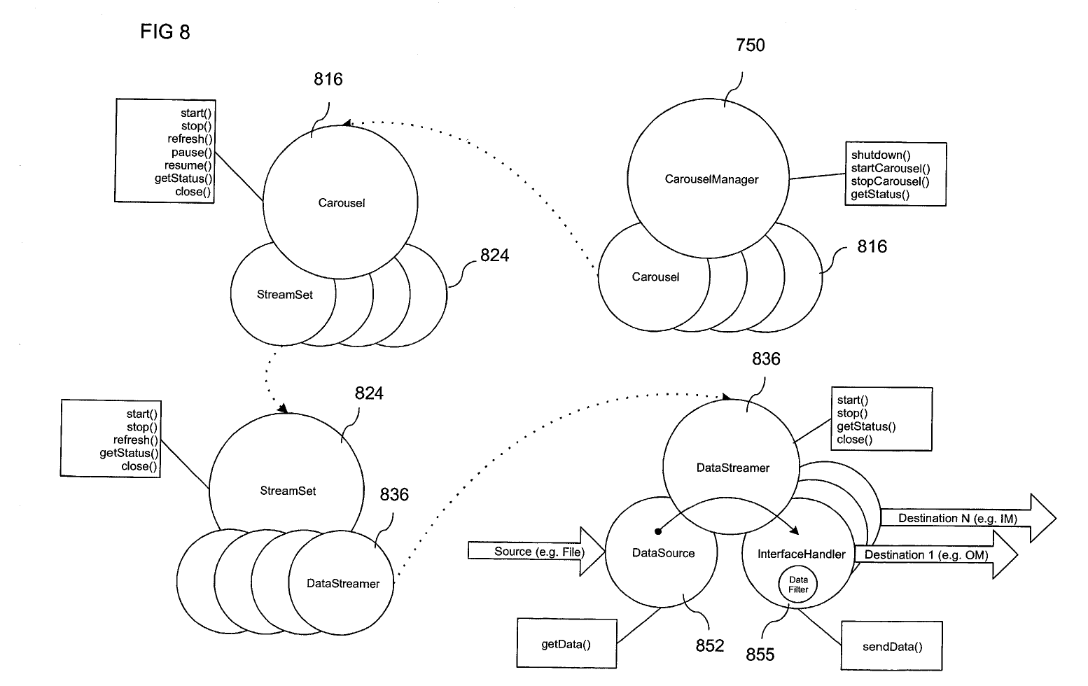

FIG. 8 is a simplified functional block diagram of a carousel manager's object hierarchy, in accordance with the invention. As shown, the carousel manager 750 may control multiple carousels 816. Each carousel 816 is responsible for generating a multiplex of stream sets 824 which, in turn, generate data streamers 836. Each data streamer 836 is responsible for obtaining data, scheduling its transmission, and transmit it to the appropriate destination. Data streamers 836 function as pipelines that are independent of source and destination. Data streamers 836 utilize data sources 852 and interface handlers 855, as indicated in FIG. 8, to respectively acquire and transmit data. As a data streamer 836 may have multiple interface handlers 855, a single data stream may, in accordance with the invention, be routed to multiple physical destinations.

The data streamers 836 may support both immediate and throttled transmission. When configured for immediate transmission, data is routed to the interface handlers 855 (or to the plurality of interface handlers) as soon as the data is received from the source. Such configuration may be desirable when implementing services using live feeds, for example. When configured for throttled transmission, data is routed from the data source 852 to the interface handler 855 at a specified rate. Such configuration may be advantageously used with file-based feeds. Generally, throttling attempts to achieve an overall average bit rate, thus data “bundles” are sent at intervals based on the average size of the prior two bundles.

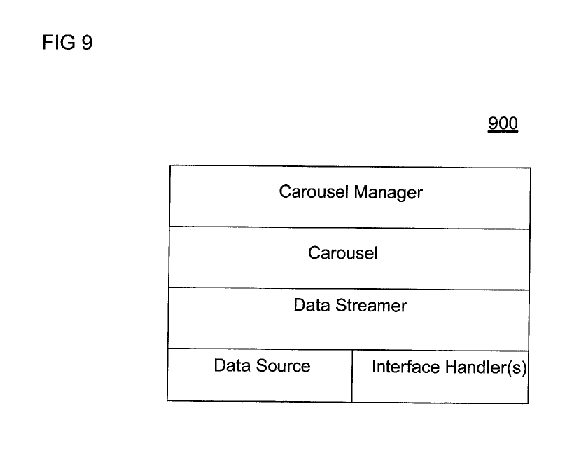

FIG. 9 summarizes the carousel manager's object hierarchy.

Other embodiments of the invention may be implemented in accordance with the claims that follow.

What is claimed is:

1. A method of providing a virtual file system including application data files to selected set-top terminals within a cable network, each of the selected set-top terminals having one or more client applications residing thereon, the method comprising the steps of:
creating a plurality of virtual streams in a single downstream service within a stream set where the virtual streams carry multicast addresses associated with the selected set-top terminals in the cable network;
streaming application data files from a data carousel onto one or more of the virtual streams; and
delivering the stream set to the client application in accordance with delivery criteria set by an API residing on the set-top terminal.

2. The method of claim 1 wherein the delivery criteria includes configuration of the virtual file system across the stream set.

3. The method of claim 2 wherein the configuration comprises partitioning.

4. The method of claim 1 wherein the delivery criteria include in-band or out-of-band transport criteria.

5. The method of claim 1 wherein the delivery criteria include bandwidth availability on the cable network.

6. The method of claim 1 wherein the delivery criteria include bit-rate.

7. The method of claim 1 wherein the stream set carries operations information.

8. The method of claim 7 wherein the operations infonnation includes structured information describing the virtual file system.

9. The method of claim 8 wherein the structured information includes an MPEG-2 PAT.

10. The method of claim 8 wherein the structured information includes an MPEG-2 PMT.

11. The method of claim 1 wherein the stream set is MPEG-2 compliant.

12. The method of claim 1 wherein the API includes wrapper functions that are provided to the client application.

13. The method of claim 1 wherein the wrapper functions include a synchronous function-call and response.

14. The method of claim 1 wherein the application data files are streamed according to a file selection algorithm.

15. The method of claim 14 wherein the file selection algorithm selects files in a virtual directory.

16. The method of claim 14 wherein the file selection algorithm selects files that are applicable to time window.

17. The method of claim 14 wherein the file selection algorithm limits selected files to those which are applicable to a sliding time window.

18. An carousel file server for use in cable network applications, comprising:
a user interface;
a carousel manager operably coupled to exchange status and control information with the user interface;
a staging area operably coupled to the carousel manager for temporarily storing uploaded application data files to the carousel manager; and
a persistent data store operably coupled to the carousel manager for storing application data files and configuration data from the staging area under control of the carousel manager,
wherein the carousel manager is arranged to transmit the application storage files repeatedly in a plurality of virtual streams within a single PID stream.

19. The carousel file server of claim 18 wherein the user interface comprises a web-browser operably coupled to a web server.

20. The carousel file server of claim 18 wherein the persistent data store further stores metadata.

21. The carousel file server of claim 18 wherein the persistent data store further stores server logs.

22. The carousel file server of claim 18 wherein the persistent data store comprises an SQL database.

23. The carousel file server of claim 18 wherein the carousel manager further includes a data streamer for obtaining and transmitting application data files.

24. The carousel file server of claim 23 wherein the data streamer comprises a data source and an interface handler.

25. The carousel file server of claim 18 wherein the carousel file manager is adapted to monitor the staging area for new or modified application data files.

26. The carousel file server of claim 25 wherein the carousel manager uploads the new or modified application data files to the persistent data store subsequent in response to the monitoring.

27. The carousel file server of claim 18 wherein the user interface, carousel manager, staging area and persistent data store are implemented using computer code embodied in computer-readable medium and resident on a programmable application server.

28. A method for providing an application programming interface (API) that is resident on a set-top terminal coupled to a cable network with virtual file mounting and directory information gathering functionality within a carousel file environment, the method comprising the steps of:
providing a plurality of wrapped code to assemble a set of related application data files from a plurality of virtual data streams or a stream set;
providing one or more wrapper functions to a client application running on the set-top terminal to access the wrapped code; and
executing a wrapped code in response to a wrapper function call placed by the client application.

29. The method of claim 28 wherein the wrapper functions are implemented using a synchronous function-call and return methodology.

30. The method of claim 28 wherein an asynchronous response to a function-call is implemented for a selected function.

31. The method of claim 30 wherein the selected function includes client application data file retrieval.

32. The method of claim 30 wherein the API is accessed through an API server resident on the set-top terminal.

33. The method of claim 30 wherein the API is resident in firmware in the set-top terminal.

34. The method of claim 30 wherein the API is downloaded to the set-top terminal as executable code.
